(19) United States
(12) Patent Application Publication
(10) Pub. No.: US 2026/0150880 A1
(43) Pub. Date: Jun. 4, 2026

(54) FILTER WRAPPER FOR AEROSOL GENERATING ARTICLES AND FILTERS FOR AEROSOL GENERATING ARTICLES INCLUDING THE SAME

(71) Applicant: KT&G CORPORATION, Daejeon (KR)

(72) Inventor: Hyeontae KIM, Daejeon (KR)

(73) Assignee: KT&G CORPORATION, Daejeon (KR)

(21) Appl. No.: 19/349,074

(22) Filed: Oct. 3, 2025

(30) Foreign Application Priority Data
Dec. 3, 2024 (KR) 10-2024-0177571

(51) Int. Cl. A24D 1/02; A24D 1/04; A24D 3/04; A24D 3/06; A24D 3/10; A24D 3/17; C09J 123/08; D21H 19/10; D21H 19/84; D21H 21/16; D21H 27/08

(52) U.S. Cl. CPC A24D 1/02; A24D 1/045; A24D 3/048; A24D 3/061; A24D 3/10; A24D 3/17; C09J 123/0853; D21H 19/10; D21H 19/84; D21H 21/16; D21H 27/08

(57) ABSTRACT

A filter wrapper for an aerosol generating article according to an embodiment includes a paper layer and a coating layer arranged on at least one surface of the paper layer, wherein the coating layer includes one or more polymer resins selected from the group consisting of acryl-based resin and polyvinyl alcohol-based resin.

### CROSS-REFERENCE TO RELATED APPLICATION

This application is based on and claims priority under 35 U.S.C. § 119 to Korean Patent Application No. 10-2024-0177571, filed on Dec. 3, 2024, in the Korean Intellectual Property Office, the disclosure of which is incorporated by reference herein in its entirety.

### BACKGROUND

### 1. Field

The disclosure relates to a filter wrapper for an aerosol generating article and a filter for an aerosol generating article that includes the filter wrapper, and more particularly, to a filter wrapper for an aerosol generating article, the filter wrapper having oil resistance and excellent adhesion to a filter tow, and a filter for an aerosol generating article, the filter including the filter wrapper.

### 2. Description of the Related Art

There is increasing demand for filters used in cigarettes (or ‘aerosol generating articles’) and including flavoring materials in addition to filter materials. Flavoring materials may add flavors to aerosols passing through the filters. The flavoring materials may be sprayed onto filter materials in liquid form or may be included in capsules and embedded in the filter materials.

### SUMMARY

In general, flavoring materials may include fat-soluble materials and cause problems such as contamination of filter wrappers by the flavoring materials. For example, in the case of filters including capsules, flavoring liquids (e.g., liquids containing flavoring materials) within the capsules may be released when the capsules are broken. The flavoring liquids may reach the filter wrappers due to the pressure applied inside the capsules when the capsules are broken. Because the flavoring liquids mainly include oil, the filter wrappers are required to have oil resistance to prevent contamination by the flavoring liquids.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

According to an embodiment, a filter wrapper for an aerosol generating article includes a paper layer and a coating layer arranged on at least one surface of the paper layer, wherein the coating layer includes one or more polymer resins selected from the group consisting of acryl-based resin and polyvinyl alcohol-based resin.

According to an embodiment, a filter for an aerosol generating article includes filter tow including a filter fiber and a filter wrapper surrounding the filter tow.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol-generating device according to an embodiment.

FIG. 2a shows an aerosol-generating device according to an embodiment.

FIG. 2b shows an aerosol-generating device according to an embodiment.

FIG. 3 shows an aerosol-generating device according to an embodiment.

FIG. 4 illustrates an aerosol generating article according to an embodiment;

FIG. 5 illustrates an aerosol generating article according to an embodiment;

FIG. 6 illustrates an aerosol generating article according to an embodiment;

FIG. 7 illustrates an aerosol generating article according to an embodiment;

FIG. 8 illustrates a filter wrapper for an aerosol generating article, according to an embodiment; and

FIG. 9 illustrates a filter for an aerosol generating article, according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first,” “second,” etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

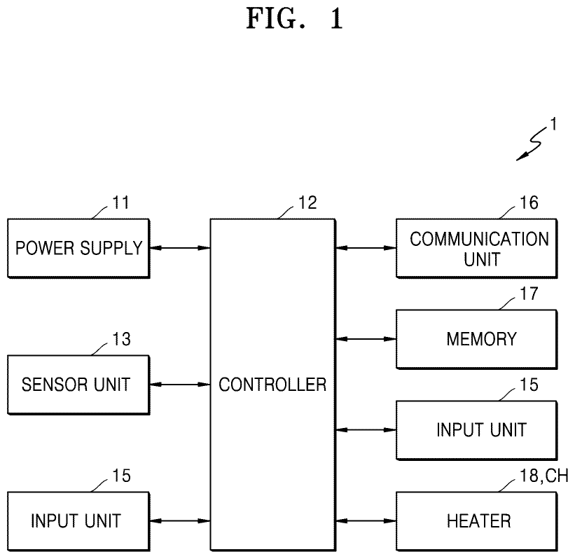

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or heater 18 or CH. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect the heating temperature of the heater 18 or CH. The aerosol generating device 1 may include a separate temperature sensor for detecting respective temperatures of the heater 18 or CH, or the heater 18 or CH may serve as a temperature sensor. For example, the temperature sensor may be used to measure an impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperatures of the heater 18 or CH. The temperature sensor may output a signal corresponding to the resistance value of the resistive element, and the controller 12 may detect the temperatures and/or temperature changes of the heater 18 or CH, based on the signal corresponding to the resistance value.

As another example, the temperature sensor may include a sensor for detecting the resistance values of the heater 18 or CH. The temperature sensor may output signals corresponding to the resistance values of the heater 18 or CH, and the controller 12 may detect the temperatures and/or temperature changes of the heater 18 or CH, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user' puff occurs, a temporary temperature drop may occur in the airflow path, a space where an aerosol generating article is inserted (hereinafter, an insertion space), the heater 18 or CH, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect the authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect the authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18 or CH, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 or CH may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 or CH may heat a medium and/or an aerosol generating material within the aerosol generating article and/or the cartridge by receiving power from the power supply 11. The aerosol generating device 1 may include a heater 18 for heating the aerosol generating article and/or a cartridge heater CH for heating the cartridge (i.e., a solid and/or liquid medium).

According to an embodiment, the heater 18 or CH may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 or CH may be induction heating heaters. For example, the induction heating heaters may include a susceptor that generates heat through a magnetic field. The magnetic field may be generated from an induction coil by an AC current flowing through the induction coil. The generated magnetic field may penetrates a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 or CH are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+ communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18 or CH, thereby controlling the temperatures of the heater 18 or CH. The controller 12 may control the temperatures of the heater 18 or CH and/or power supplied to the heater 18 or CH, based on the temperatures of the heater 18 or CH detected using the temperature sensor (e.g., the sensor unit 13). The controller 12 may control the temperatures of the heater 18 or CH and/or the power supplied to the heater 18 or CH, based on a temperature profile and/or a power profile stored in the memory 17.

According to an embodiment, the controller 12 may control power (e.g., a voltage and/or a current) supplied to the heater 18 or CH by controlling a power conversion circuit (not shown) electrically connected to the heater 18 or CH and the power supply 11. For example, the power conversion circuit may include a DC/DC converter (e.g., a buck converter, a buck-boost converter, a boost converter, or a Zener diode) that converts power that is to be supplied to the heater 18 or CH, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 or CH by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18 or CH, by using at least one method among a pulse width modulation (PWM) method and a proportional-integral-differential (PID) method. For example, the controller 12 may control a current pulse having a certain frequency and a duty ratio to be supplied to the heater 18 or CH, by using the PWM method. The controller 12 may control the power supplied to the heater 18 or CH, by adjusting the frequency and duty ratio of the current pulse. For example, the controller 12 may determine a target temperature that is a target of control, based on the temperature profile. The controller 12 may control the power supplied to the heater 18 or CH, by using a PID method, which is a feedback control method using a difference value between the temperatures of the heater 18 or CH and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 or CH to correspond to preset target power, according to the flow of time.

According to an embodiment, the controller 12 may detect the user's puff by detecting the power supplied to the heater 18 or CH. In more detail, the controller 12 may control the power supplied to the heater 18 or CH, by using the PID method. When the user' puff occurs, a temporary temperature drop may occur in a space where the aerosol generating article is inserted (hereinafter, the insertion space), the heater 18 or CH, etc. Accordingly, a change may occur in the power (or current) supplied to the heater 18 or CH during power control using the PID method. The controller 12 may detect the user's puff, based on a change in the power that is controlled.

According to an embodiment, the controller 12 may prevent the heater 18 or CH from being heated. For example, the controller 12 may control an operation of the power conversion circuit so that the amount of the power supplied to the heater 18 or CH is reduced or the power supply to the heater 18 or CH is stopped, based on the temperatures of the heater 18 or CH exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18 or CH, based on a result of the sensing performed by the sensor 13.

According to an embodiment, the controller 12 may control supply of power to the heater 18 or CH, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18 or CH. When it is determined using the insertion detection sensor (e.g., the sensor unit 13) that the aerosol generating article has been removed from the insertion space, the controller 12 may block the supply of power to the heater 18 or CH. When the temperatures of the heater 18 or CH are equal to or greater than a limit temperature or temperature change slopes of the heater 18 or CH are equal to or greater than a set slope, the controller 12 may determine that the aerosol generating article has been removed from the insertion space.

According to an embodiment, the controller 12 may control power supply time periods and/or power supply amounts for the heater 18 or CH, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18 or CH.

According to an embodiment, the controller 12 may control supply of power to the heater 18 or CH, based on reuse or non-reuse of the aerosol generating article. For example, when it is determined that the aerosol generating article has been used, the controller 12 may block supply of power to the heater 18 or CH.

According to an embodiment, the controller 12 may control supply of power to the heater 18 or CH, based on attachment and/or removal of the cartridge. For example, when it is determined using the cartridge detection sensor (e.g., the sensor unit 13) that the cartridge is in a separated state, the controller 12 may block supply of power to the heater 18 or CH or may control power to be not supplied to the heater 18 or CH.

According to an embodiment, the controller 12 may control supply of power to the heater 18 or CH, based on whether the aerosol generating material of the cartridge has been exhausted. For example, when it is determined that the temperatures of the heater 18 or CH exceed the limit temperature while the heater 18 or CH are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18 or CH.

According to an embodiment, the controller 12 may control the supply of power to the heater 18 or CH, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 or CH are heated is greater than or equal to a preset maximum time period or a total amount of power supplied to the heater 18 or CH is greater than or equal to a preset maximum power amount, the controller 12 may determine that the use of the cartridge is not possible. In this case, the controller 12 may block supply of power to the heater 18 or CH or may control power to be not supplied to the heater 18 or CH.

According to an embodiment, the controller 12 may control the supply of power to the heater 18 or CH, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18 or CH. When a puff is sensed, the controller 12 may control the supply of power to the heater 18 or CH.

According to an embodiment, the controller 12 may control supply of power to the heater 18 or CH, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18 or CH. When the aerosol generating article (or the cartridge) is detected as authentic, the controller 12 may control (e.g., start) supply of power to the heater 18 or CH. As another example, the controller 12 may differently control power supply to the heater 18 or CH according to the types of aerosol generating article (or cartridge). In more detail, when the aerosol generating article (or the cartridge) is detected as a first aerosol generating article (or a first cartridge), the controller 12 may control the temperatures and/or power of the heater 18 or CH, based on a first temperature profile (or a first power profile), and, when the aerosol generating article (or cartridge) is detected as a second aerosol generating article (or a second cartridge), may control the temperatures and/or power of the heater 18 or CH, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18 or CH.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18 or CH, detection of overvoltage application to the heater 18 or CH, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18 or CH, the log data corresponding to the event may include data about, for example, the temperature of the heater 18 or CH, the voltage applied to the heater 18 or CH, and the current flowing through the heater 18 or CH.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater CH may be included in the cartridge, as a coil-shaped structure that is wound around the liquid delivery unit or in a structure in contact with one side of the liquid delivery unit. Alternatively, the cartridge heater CH may be included in an aerosol generating device 1 that is separable from the cartridge.

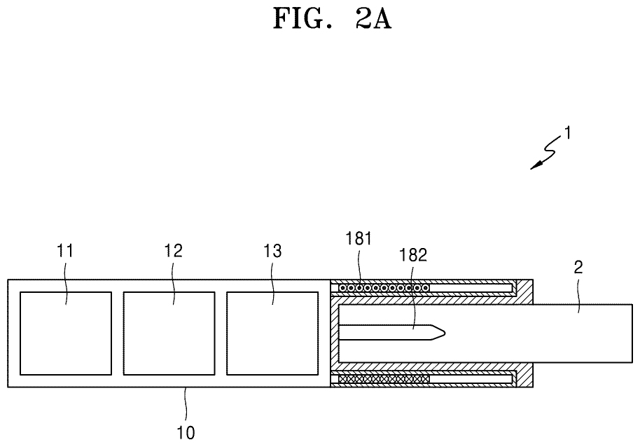

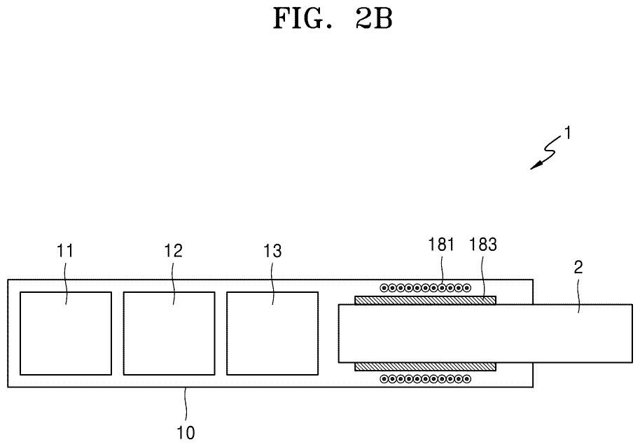

FIG. 2a illustrates an aerosol generating device according to an embodiment. FIG. 2b illustrates an aerosol generating device according to an embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2a or 2b. It may be understood by those skilled in the art that some of the components shown in FIG. 2a or 2b may be omitted or new components may be added. The aerosol generating device 1 illustrated in FIG. 2a may be referred to as an ‘internal heating type’ aerosol generating device that heats the inside of an aerosol generating article 2. The aerosol generating device 1 illustrated in FIG. 2b may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2a, the heater 182 may be implemented as an internal heating heater.

According to an embodiment, the internal heating heater may extend long upward in a space (i.e., the insertion space) into which the aerosol generating article 2 is inserted. As illustrated in FIG. 2a, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

According to an embodiment, the heater 182 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 2b, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 2b that overlaps with FIG. 2a will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what shown in FIG. 2a or FIG. 2b, the heater 182 of FIG. 2a and the heater 183 of FIG. 2b may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

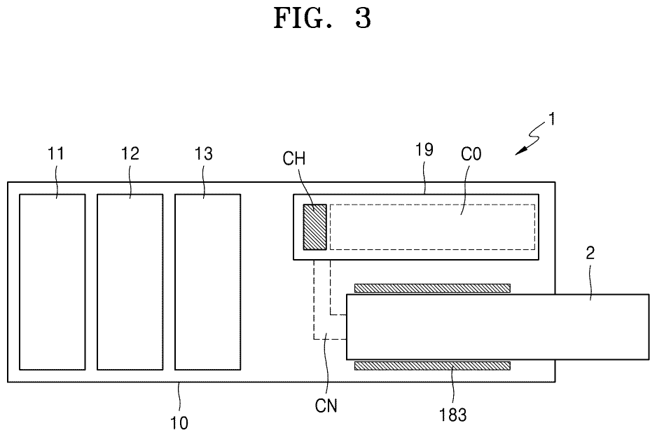

FIG. 3 shows an aerosol-generating device 1 according to an embodiment.

According to one embodiment, the aerosol-generating device 1 may include a housing 10, a power supply 11, a controller 12, a sensor unit 13, and/or a heater 183 and CH (e.g., the heater 18 and CH in FIG. 1). However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater CH or may not be substantially heated. Indirect heating may mean that the aerosol-generating article 2 is heated by receiving heat contained in the aerosol during the process in which the aerosol generated by the cartridge heater CH passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the airflow channel CN, and then may flow to the user's oral cavity. The airflow channel CN may include various structures for reducing residual droplets or making the flow of air smooth.

Although it is illustrated in FIG. 3 that the cartridge 19 is located beside the aerosol-generating article 2 and the airflow channel CN is formed from the side surface of the aerosol-generating article 2 to the lower end (i.e., upstream side) of the aerosol-generating article 2, the positions of the cartridge 19 and the airflow channel CN are not limited thereto. For example, the cartridge 19 may be located adjacent to the lower end (i.e., upstream side) of the aerosol-generating article 2. In this case, the airflow channel CN may be formed in a substantially straight shape to connect the cartridge 19 to the lower end (i.e., upstream side) of the aerosol-generating article 2.

According to one embodiment, the cartridge 19 may include a storage part CO that contains an aerosol-generating substance, a cartridge heater CH, and/or a liquid delivery part that is impregnated with (contains) the aerosol-generating substance. The liquid delivery part 25 may be impregnated with the aerosol-generating substance supplied from the chamber CO. For example, the liquid delivery part may include a wick formed of, e.g., cotton fiber, ceramic fiber, glass fiber, or porous ceramic.

According to one embodiment, the cartridge heater CH may heat the aerosol-generating substance contained in the cartridge 19. For example, the cartridge heater CH may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater.

The induction heater may include a susceptor, and may generate heat based on a magnetic field generated by the induction coil (not shown). The cartridge heater CH may be formed in a coil shape surrounding (or wound around) the liquid delivery part and/or in a shape (e.g., a patterned shape) contacting one side of the liquid delivery part.

Unlike the configuration shown in the drawings, the cartridge heater CH may be included in the aerosol-generating device 1. For example, the cartridge heater CH may be included inside the housing 10. In this case, the cartridge 19 and the cartridge heater CH may be separated by removal of the cartridge 19.

According to one embodiment, an aerosol may be generated based on generation of heat by the cartridge heater CH. For example, as the aerosol-generating substance impregnated in the liquid delivery part is heated by the cartridge heater CH, vapor may be generated from the aerosol-generating substance, and an aerosol may be generated as the generated vapor is mixed with the outside air introduced into the cartridge 19. The aerosol generated by the cartridge heater CH may be introduced into the aerosol-generating article 2 through the airflow channel CN. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

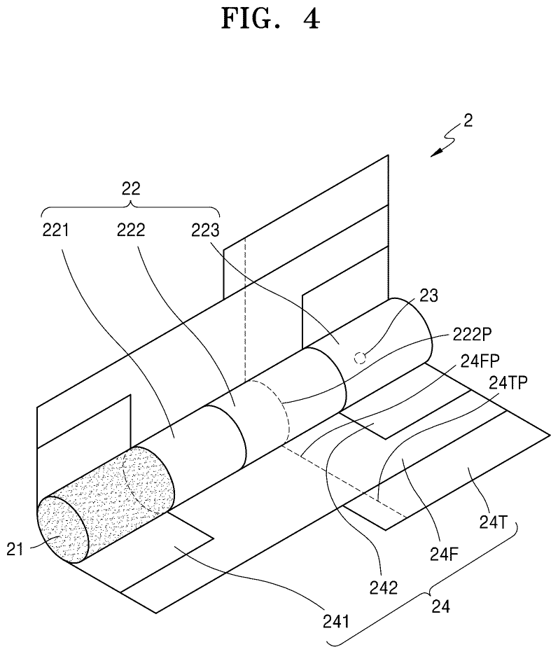

FIG. 4 illustrates the aerosol generating article 2 according to an embodiment.

Referring to FIG. 4, the aerosol generating article 2 may include an aerosol generating rod 21 and a filter rod 22. Also, the aerosol generating article 2 may be packaged in at least one wrapper 24.

The aerosol generating rod 21 may include a tobacco material and/or a non-tobacco material. The tobacco material and the non-tobacco material may include nicotine and may be heated to generate aerosols containing nicotine vapor. The tobacco material and the non-tobacco material may be in various forms. For example, the tobacco material and the non-tobacco material may each have at least one form from among sheets, pipe tobacco, strands, particles, beads, granules, powders, and extracts, but the form is limited thereto.

The tobacco material may be manufactured using leaf tobacco ingredients and/or reconstituted tobacco ingredients. The leaf tobacco ingredients may include at least one of yellow tobacco, burley tobacco, and oriental tobacco, but one or more embodiments are not limited thereto. The reconstituted tobacco ingredients may refer to tobacco ingredients that are reconstituted using tobacco byproducts. For example, the reconstituted tobacco ingredients may include tobacco sheets.

The non-tobacco material may be manufactured without using tobacco ingredients. For example, the non-tobacco material may be manufactured using cellulose, nicotine, organic acid, or the like. In addition, the non-tobacco material may be manufactured using cellulose, nicotine salt, or the like, but one or more embodiments are not limited thereto.

The tobacco material and the non-tobacco material may include aerosol generating materials. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco material may include other additives, such as flavoring agents and organic acids.

The aerosol generating rod 21 may include at least one tobacco sheet. The tobacco sheet may include at least one of a slurry-type tobacco sheet and a paper-type tobacco sheet. The slurry-type tobacco sheet and the paper-type tobacco sheet may be distinguished based on manufacturing methods thereof. At least one tobacco sheet may be arranged to extend along the longitudinal direction of the aerosol generating rod 21. However, one or more embodiments are not limited thereto, and the aerosol generating rod 21 may include a plurality of cut tobacco sheets manufactured by cutting or finely cutting the tobacco sheet. In addition, the tobacco sheet may be crimped to include wrinkles, and the aerosol generating rod 21 may include a crimped tobacco sheet or a plurality of cut tobacco sheets made from the crimped tobacco sheet.

The aerosol generating rod 21 may include at least one of an expanded stem and an expanded midrib. The expanded stem and the expanded midrib may be manufactured by expanding leaf tobacco ingredients and byproducts thereof, such as midribs.

The filter rod 22 may include a plurality of segments. Referring to FIG. 4, the filter rod 22 may include a first segment 221, a second segment 222, and a third segment 223. The first segment 221, the second segment 222, and the third segment 223 may be sequentially arranged along the longitudinal direction of the aerosol generating article 2.

The first segment 221 may support a tobacco material included in the aerosol generating rod 21. The first segment 221 may be arranged adjacent to a downstream end of the aerosol generating rod 21. The first segment 221 may prevent a tobacco material from being pushed downstream while the heater 18 of the aerosol generating device 1 is inserted into the aerosol generating rod 21 through an upstream end of the aerosol generating rod 21.

The first segment 221 may include a filter material. For example, the first segment 221 may include at least one filter material selected from paper, cellulose acetate, polylactic acid, polypropylene, and lyocell. The first segment 221 may be a cylindrical rod or a tube-type rod including a hollow inside, but one or more embodiments are not limited thereto.

The second segment 222 may cool an aerosol. A high-temperature aerosol generated by the aerosol generating rod 21 may be cooled via the second segment 222.

The second segment 222 may include a filter material. For example, the second segment 222 may include at least one filter material selected from paper, cellulose acetate, polylactic acid, polypropylene, and lyocell. The second segment 222 may be a cylindrical rod or a tube-type rod including a hollow inside, but one or more embodiments are not limited thereto. For example, the second segment 222 may be a paper tube formed of paper.

The first segment 221 and the second segment 222 may each be a tube-type rod including a hollow. The diameter of the hollow of the second segment 222 may be greater than that of the hollow of the first segment 221. Accordingly, the air current flowing from the first segment 221 to the second segment 222 may accelerate, and thus, the aerosol may be effectively cooled.

The second segment 222 may include a cooling material. For example, the cooling material may include a polymer material having a cooling function. The polymer material having a cooling function may absorb heat from the aerosol when contacting the high-temperature aerosol. The polylactic acid having a cooling function may include polylactic acid, but is not limited thereto. As another example, the second segment 222 may be a tube-type rod having a hollow inside, and the polymer material having a cooling function may be applied to the surface of the hollow.

The second segment 222 may include at least one perforation 222P. The perforation 222P may be formed along the circumferential direction of the second segment 222 and form at least one column. External air may be introduced into the second segment 222 through the perforation 222P. The external air flowing into the second segment 222 may be mixed with the high-temperature aerosol generated by the aerosol generating rod 21, thereby cooling the aerosol. When the aerosol generating article 2 is inserted into the aerosol generating device 1, the perforation 222P may be exposed to the outside of the aerosol generating device 1.

The third segment 223 may filter some components included in the aerosol passing through the third segment 223. The third segment 223 may include a filter material. For example, the third segment 223 may include at least one filter material selected from paper, cellulose acetate, polylactic acid, polypropylene, and lyocell. For example, the third segment 223 may be manufactured by adding a plasticizer (e.g., triacetin) to cellulose acetate tow.

The third segment 223 may be a cylindrical rod or a tube-type rod including a hollow inside, but the shape of the third segment 223 is not limited thereto.

The third segment 223 may add flavors to the aerosol passing through the third segment 223. For example, the third segment 223 may include a flavoring agent. The flavoring agent may be sprayed onto the third segment 223 in liquid form, but is not limited thereto.

The flavoring agent may include menthol, but is not limited thereto. For example, the flavoring agent may also include plant-based flavors, such as cinnamon, sage, herbs, chamomile, kudzu (galcho), licorice, lavender, bergamot, lemon, orange, jasmine, ginger, vanilla, spearmint, peppermint, acacia, coffee, celery, sandalwood, and cocoa. As another example, the flavoring agent may include animal-derived flavors, such as musk, ambergris, civet, and castoreum.

The flavoring agent may be an alcohol compound, such as geraniol, linalool, anethol, or eugenol. The flavoring agent may be an aldehyde compound such as vanillin, benzaldehyde, anisaldehyde, or the like. The flavoring agent may be an ester compound, such as isoamyl acetate, linalyl acetate, isoamyl propionate, or linalyl butyrate.

The third segment 223 may include at least one capsule 23. The at least one capsule 23 may be embedded in the filter material. The capsule 23 may generate flavors or aerosols. For example, the capsule 23 may have a structure in which a liquid containing a flavoring agent is enclosed by a film. The film of the capsule 23 may be broken by external pressure and release the liquid therein. The liquid released from the capsule 23 may be absorbed into the filter material of the third segment 223. The capsule 23 may have a spherical or cylindrical shape, but is not limited thereto.

The third segment 223 may include an adsorbent. The adsorbent may adsorb a specific material in gaseous form. For example, the adsorbent may include at least one of activated carbon, zeolite, alumina, silica gel, and bentonite.

The aerosol generating article 2 may include a wrapper 24 that surrounds at least a portion of the aerosol generating rod 21 and/or at least a portion of the filter rod 22. The wrapper 24 may include a single wrapper or a combination of multiple wrappers, such as a first wrapper 241, a second wrapper 242, a final wrapper 24F, and tip paper 24T.

The wrapper 24 may include paper. For example, the wrapper 24 may include paper having a thickness of about 10 μm to about 150 μm and a basis weight of about 20 g/m² to about 100 g/m², but one or more embodiments are not limited thereto. When the wrapper 24 includes a plurality of wrappers, the thickness and basis weight of the paper in each wrapper may be the same or different.

The aerosol generating article 2 may be wrapped multiple times by two or more wrappers. For example, the aerosol generating rod 21 may be packaged by the first wrapper 241, the filter rod 22 may be packaged by the second wrapper 242, and the aerosol generating rod 21 and the filter rod 22 may be repackaged by the final wrapper 24F.

The first wrapper 241 may surround the aerosol generating rod 21. The first wrapper 241 may include a heat-conductivity improving material. The heat-conductivity improving material may include metal foil such as aluminum foil, but is not limited thereto. The heat-conductivity improving material may improve the heat conductivity of the first wrapper 241 and thus evenly distribute the heat transmitted to the aerosol generating rod 21. For example, the first wrapper 241 may be a laminated sheet in which paper and metal foil are stacked. The first wrapper 241 may be a laminated sheet in which paper is placed on one surface of the metal foil or in which paper is placed on both surfaces of the metal foil.

The second wrapper 242 may surround the filter rod 22. FIG. 4 illustrates that the second wrapper 242 surrounds only the third segment 223 among the segments of the filter rod 22, but one or more embodiments are not limited thereto. For example, the second wrapper 242 may surround the second segment 222 and the third segment 223 or completely surround the filter rod 22. The aerosol generating article 2 may include separate wrappers that respectively surround the first segment 221, the second segment 222, and the third segment 223.

The second wrapper 242 may have oil resistance. As the second wrapper 242 has oil resistance, leakage of flavoring agents in the third segment 223 and/or the capsule 23 to the outside of the aerosol generating article 2 may be prevented. For example, the second wrapper 242 may include at least one of polyvinyl alcohol and silicon. The surface of the second wrapper 242 may be coated with an oil-resistant material.

The final wrapper 24F may collectively surround the aerosol generating rod 21 and the filter rod 22. The final wrapper 24F may protect the outer surface of the aerosol generating article 2 to facilitate smooth insertion of the aerosol generating article 2 into the aerosol generating device 1.

The final wrapper 24F may include at least one perforation 24FP. For example, the final wrapper 24F may surround the second segment 222, and the perforation 24FP of the final wrapper 24F may be at a location corresponding to the perforation 222P of the second segment 222.

The wrapper 24 may include tip paper 24T. The tip paper 24T may surround some portions of the aerosol generating article 2 extending from the downstream end of the aerosol generating article 2 in the longitudinal direction of the aerosol generating article 2. For example, the tip paper 24T may surround the entire third segment 223 and a portion of the second segment 222. The tip paper 24T may come into contact with the user's mouth during the use of the aerosol generating article 2.

The tip paper 24T may include at least one perforation 24TP. For example, the tip paper 24T may surround the second segment 222, and the perforation 24TP of the tip paper 24T may be at a location corresponding to the perforation 222P of the second segment 222.

The outer surface of the tip paper 24T may be coated with a material, such as a sweetener and a lip release agent. The sweetener may provide a sweet flavor to the user. For example, the sweetener may include sucralose, citric acid, or the like, but is not limited thereto. The lip release agent may allow the user's mouth to be easily separated from the tip paper 24T after contacting the tip paper 24T. For example, the lip release agent may include at least one of nitrocellulose, ethyl acetate, polyamide, and isopropylalcohol, but is not limited thereto.

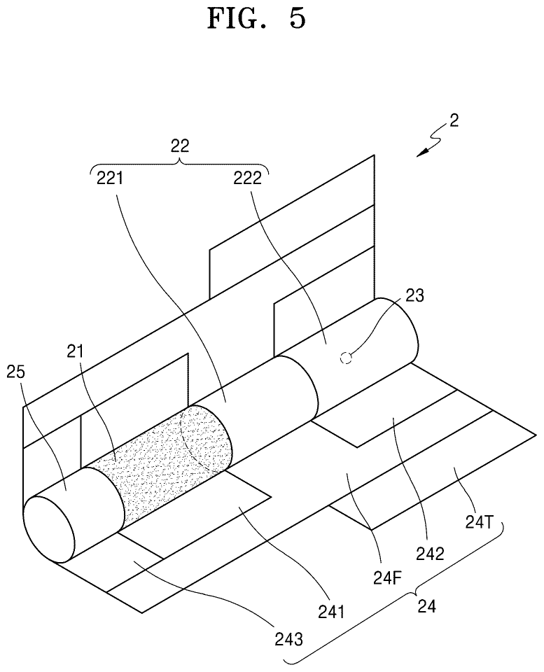

FIG. 5 illustrates the aerosol generating article 2 according to an embodiment.

Referring to FIG. 5, the aerosol generating article 2 may include the aerosol generating rod 21, the filter rod 22, and a front-end plug 25. Also, the aerosol generating article 2 may be packaged by at least one wrapper 24.

The front-end plug 25 may introduce external air to the inside of the aerosol generating article 2. For example, the aerosol generated by the cartridge 19 of the aerosol generating device 1 may be introduced to the aerosol generating rod 21 through the front-end plug 25.

The front-end plug 25 may be located on one side of the aerosol generating rod 21 which is opposite to the filter rod 22. For example, the front-end plug 25, the aerosol generating rod 21, and the filter rod 22 may be sequentially arranged in the longitudinal direction of the aerosol generating article 2. The front-end plug 25 may prevent the tobacco material in the aerosol generating rod 21 from moving towards an upstream end of the aerosol generating rod 21.

The front-end plug 25 may include a filter material. For example, the front-end plug 25 may include at least one filter material selected from paper, cellulose acetate, polylactic acid, polypropylene, and lyocell. For example, the front-end plug 25 may be manufactured by adding a plasticizer (e.g., triacetin) to cellulose acetate tow.

The front-end plug 25 may be a tube-type rod including a hollow inside. The aerosol generated by the cartridge 19 of the aerosol generating device 1 may be introduced to the aerosol generating rod 21 through the hollow of the front-end plug 25. For example, the front-end plug 25 may include a hollow that extends from the upstream end of the front-end plug 25 to the downstream end thereof. The cross-section of the hollow may have various forms, such as a circle, an oval, a polygon, a cross, and a Y shape, but the shape is not limited thereto. As another example, the front-end plug 25 may be a cylindrical rod that does not include a hollow.

The front-end plug 25 may add a flavor to the aerosol passing through the front-end plug 25. For example, the front-end plug 25 may include a flavoring agent. The flavoring agent may be sprayed onto the front-end plug 25 in liquid form, but is not limited thereto.

Because at least one of the components of the aerosol generating article 2 shown in FIG. 5 is the same as or similar to at least one of the components of the aerosol generating article 2 shown in FIG. 4, repeated descriptions are omitted.

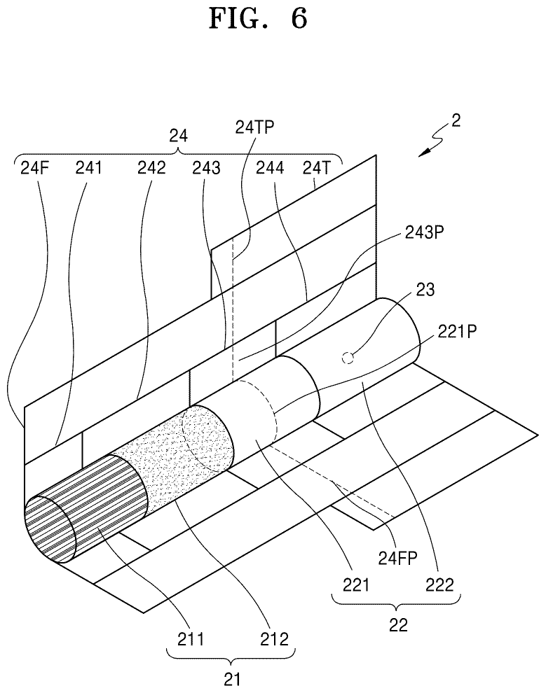

FIG. 6 illustrates the aerosol generating article 2 according to an embodiment.

Referring to FIG. 6, the aerosol generating article 2 may include an aerosol generating rod 21 and a filter rod 22. Also, the aerosol generating article 2 may be packaged by at least one wrapper 24.

The aerosol generating rod 21 may include a first aerosol generating rod 211 and a second aerosol generating rod 212. The first aerosol generating rod 211 and the second aerosol generating rod 212 may be sequentially arranged in the longitudinal direction of the aerosol generating article 2. However, one or more embodiments are not limited thereto, and the arrangement order of the first aerosol generating rod 211 and the second aerosol generating rod 212 may change.

The first aerosol generating rod 211 may be heated, thus generating an aerosol. The aerosol generated by the first aerosol generating rod 211 may include or not include nicotine. The first aerosol generating rod 211 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the first aerosol generating rod 211 may include other additives, such as flavoring agents and organic acids.

The first aerosol generating rod 211 may include an aerosol generating substrate impregnated with the aerosol generating material in liquid form. The aerosol generating substrate may have a sheet shape. For example, the aerosol generating substrate may be crimped to include wrinkles. The aerosol generating substrate in a crimped sheet shape may be included in the first aerosol generating rod 211 in a rolled state. The aerosol generating substrate may be rolled around the axis extending along the longitudinal direction of the aerosol generating article 2, but one or more embodiments are not limited thereto.

The aerosol generating substrate may include a polymer material. The polymer material may include at least one of paper, cellulose, cellulose acetate, lyocell, and polylactic acid. For example, the aerosol generating substrate may be a paper sheet that, even when heated at a high temperature, does not produce a heat-induced odor.

The second aerosol generating rod 212 may be heated, thus generating an aerosol containing nicotine vapor. For example, the second aerosol generating rod 212 may include a tobacco material and/or a non-tobacco material. The tobacco material and the non-tobacco material may be in various forms. For example, the tobacco material and the non-tobacco material may each have at least one form from among sheets, pipe tobacco, strands, particles, beads, granules, powders, and extracts, but the form is limited thereto.

The tobacco material may be manufactured using at least one of leaf tobacco ingredients and reconstituted tobacco ingredients. The leaf tobacco ingredients may include at least one of yellow tobacco, burley tobacco, and oriental tobacco, but one or more embodiments are not limited thereto. The reconstituted tobacco ingredients may refer to tobacco ingredients that are reconstituted using tobacco byproducts. For example, the reconstituted tobacco ingredients may include tobacco sheets.

The non-tobacco material may be manufactured without using tobacco ingredients. For example, the non-tobacco material may be manufactured using cellulose, nicotine, organic acid, or the like. In addition, the non-tobacco material may be manufactured using cellulose, nicotine salt, or the like, but one or more embodiments are not limited thereto.

The tobacco material and the non-tobacco material may include aerosol generating materials. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco material may include other additives, such as flavoring agents and organic acids.

For example, the second aerosol generating rod 212 may include a plurality of cut tobaccos. The cut tobacco may be manufactured according to a manufacturing method including mixing leaf tobacco ingredients, adding flavors to the mixed leaf tobacco ingredients, and manufacturing cut tobacco by chopping the flavored leaf tobacco ingredients.

In the mixing of the leaf tobacco ingredients, leaf tobacco ingredients of different types are mixed at predetermined ratios. For example, the mixing of the leaf tobacco ingredients may include mixing yellow tobacco with burley tobacco. However, one or more embodiments are not limited thereto, and a single type of leaf tobacco ingredients may be used.

In the adding of the flavors to the mixed leaf tobacco ingredients, the occurrence of irritation or unpleasant taste during smoking may be suppressed, and properties such as moisture retention and aroma stability may be imparted to the cut tobacco. The adding may include spraying a flavoring liquid onto the leaf tobacco ingredients. The flavoring liquid may be a mixture of sugars (e.g., sucrose), organic acids (e.g., citric acid, tartaric acid, etc.), aerosol generating materials (e.g., glycerin, propylene glycol, etc.), and flavoring agents (e.g., licorice extract, cocoa, etc.).

The second aerosol generating rod 212 may include at least one tobacco sheet. The tobacco sheet may include at least one of a slurry-type tobacco sheet and a paper-type tobacco sheet. The slurry-type tobacco sheet and the paper-type tobacco sheet may be distinguished based on manufacturing methods thereof. At least one tobacco sheet may be arranged to extend along the longitudinal direction of the second aerosol generating rod 212. However, one or more embodiments are not limited thereto, and the second aerosol generating rod 212 may include a plurality of cut tobacco sheets manufactured by cutting or finely cutting the tobacco sheet. In addition, the tobacco sheet may be crimped to include wrinkles, and the second aerosol generating rod 212 may include a crimped tobacco sheet or a plurality of cut tobacco sheets made from the crimped tobacco sheet.

The second aerosol generating rod 212 may include at least one of an expanded stem and an expanded midrib. The expanded stem and the expanded midrib may be manufactured by expanding leaf tobacco ingredients and byproducts thereof, such as midribs.

The second aerosol generating rod 212 may include a plurality of tobacco granules. The tobacco granules may be particles with a diameter of about 100 μm to about 2000 μm. For example, the tobacco granules may be particles with a diameter of about 200 μm to about 1000 μm.

The tobacco granules may be manufactured by putting a granule core into a fluidized bed reactor and then spraying a tobacco mixture into the fluidized bed reactor. The tobacco mixture adheres to and aggregates on the surface of the granule core within the fluidized bed reactor, and the size of the granule core increases so that the tobacco granules may be manufactured. The granule core may include tobacco powder manufactured by grinding tobacco leaves or stems. Here, the tobacco powder may be a particle having a diameter of about 10 μm to about 80 μm. In addition, the tobacco mixture may be a mixture of tobacco ingredients with a solvent (e.g., water).

As another example, the tobacco granule may be manufactured by wet-extruding the tobacco mixture containing the tobacco ingredients and the solvent and then spherionizing the extrudate. Here, water, alcohols (e.g., ethanol), or the like may be used as solvents, and additives, such as flavoring agents, organic acids, or pH adjusters, may be added.

The tobacco granules may be located between the filter materials. The filter material may include at least one of paper, cellulose acetate, polylactic acid, polypropylene, and lyocell. For example, the second aerosol generating rod 212 may include fibers of the filter materials, and the tobacco granules may be evenly distributed among the fibers of the filter materials.

In addition, the filter material may include a sheet-like material. For example, the filter material may include a paper sheet. The paper sheet may be included in the second aerosol generating rod 212 in a rolled form. The paper sheet may be rolled around the axis extending along the longitudinal direction of the aerosol generating article 2, but one or more embodiments are not limited thereto. The tobacco granules may be uniformly distributed in the rolled paper sheet. The paper sheet may be a rolled sheet on which folds are formed.

The second aerosol generating rod 212 may include an aerosol generating substrate impregnated with a nicotine liquid composition. The description regarding the first aerosol generating rod 211 may be identically or similarly applied to the aerosol generating substrate.

The nicotine liquid composition may contain nicotine. Nicotine may include freebase nicotine and nicotine salts. Freebase nicotine may refer to neutral nicotine to which protons are not added. For example, when a base is added to nicotine salt carrying a positive charge, the base may form cations, and the nicotine salt may be converted into neutral freebase nicotine.

The nicotine salt may include an acid. For example, the nicotine salt may include at least one of acetic acid, benzoic acid, lactic acid, carbonic acid, citric acid, gallic acid, lauric acid, levulinic acid, malic acid, malonic acid, oxalic acid, oxaloacetic acid, palmitic acid, pyruvic acid, phosphoric acid, salicylate, sorbic acid, stearic acid, and tartaric acid.

The nicotine liquid composition may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. The nicotine liquid composition may include other additives, such as flavoring agents and organic acids.

The nicotine liquid composition may include nicotine in an amount of about 0.1 wt % to about 5 wt % based on the total weight of the nicotine liquid composition. For example, the nicotine liquid composition may include nicotine in an amount of about 0.5 wt % to about 3 wt % based on the total weight of the nicotine liquid composition.

The nicotine liquid composition may be impregnated in an amount of about 0.05 g to about 5.0 g per 1 g of the aerosol generating substrate. For example, the nicotine liquid composition may be impregnated in an amount of about 0.1 g to about 2.0 g per 1 g of the aerosol generating substrate.

The filter rod 22 may include a plurality of segments. Referring to FIG. 6, the filter rod 22 may include a first segment 221 and a second segment 222. The first segment 221 and the second segment 222 may be sequentially arranged along the longitudinal direction of the aerosol generating article 2.

The first segment 221 may cool an aerosol. A high-temperature aerosol generated by the aerosol generating rod 21 may be cooled via the first segment 221.

The first segment 221 may include a filter material. For example, the first segment 221 may include at least one filter material selected from paper, cellulose acetate, polylactic acid, polypropylene, and lyocell. The first segment 221 may be a cylindrical rod or a tube-type rod including a hollow inside, but is not limited thereto.

The first segment 221 may include a cooling material. For example, the cooling material may include a polymer material having a cooling function. The polymer material having a cooling function may absorb heat from the aerosol when contacting the high-temperature aerosol. The polymer material having a cooling function may include polylactic acid, but is not limited thereto. As another example, the first segment 221 may be a tube-type rod having a hollow inside, and the polymer material having a cooling function may be applied to the surface of the hollow.

The first segment 221 may include at least one perforation 221P. The perforation 221P may be formed along the circumferential direction of the first segment 221 and thus form at least one column. External air may be introduced into the first segment 221 through the perforation 221P. The external air flowing into the first segment 221 may be mixed with the high-temperature aerosol generated by the aerosol generating rod 21, thereby cooling the aerosol. When the aerosol generating article 2 is inserted into the aerosol generating device 1, the perforation 221P may be exposed to the outside of the aerosol generating device 1.

The second segment 222 may filter some components included in the aerosol passing through the second segment 222. The second segment 222 may include a filter material. For example, the second segment 222 may include at least one filter material selected from paper, cellulose acetate, polylactic acid, polypropylene, and lyocell. For example, the second segment 222 may be manufactured by adding a plasticizer (e.g., triacetin) to cellulose acetate tow.

The second segment 222 may be a cylindrical rod or a tube-type rod including a hollow inside, but the shape of the second segment 222 is not limited thereto. For example, the second segment 222 may include a hollow having an open downstream end.

The second segment 222 may add a flavor to the aerosol passing through the second segment 222. For example, the second segment 222 may include a flavoring agent. The flavoring agent may be sprayed onto the second segment 222 in liquid form, but is not limited thereto.

The flavoring agent may include menthol, but is not limited thereto. For example, the flavoring agent may also include plant-based flavors, such as cinnamon, sage, herbs, chamomile, kudzu (galcho), licorice, lavender, bergamot, lemon, orange, jasmine, ginger, vanilla, spearmint, peppermint, acacia, coffee, celery, sandalwood, and cocoa. As another example, the flavoring agent may include animal-derived flavors, such as musk, ambergris, civet, and castoreum.

The flavoring agent may be an alcohol compound, such as geraniol, linalool, anethol, or eugenol. The flavoring agent may be an aldehyde compound such as vanillin, benzaldehyde, anisaldehyde, or the like. The flavoring agent may be an ester compound, such as isoamyl acetate, linalyl acetate, isoamyl propionate, or linalyl butyrate.

The second segment 222 may include at least one capsule 23. The at least one capsule 23 may be embedded in the filter material. The capsule 23 may generate flavors or aerosols. For example, the capsule 23 may have a structure in which a liquid containing a flavoring agent is enclosed by a film. The film of the capsule 23 may be broken by external pressure and release the liquid therein. The liquid released from the capsule 23 may be absorbed into the filter material of the second segment 222. The capsule 23 may have a spherical or cylindrical shape, but is not limited thereto.

The second segment 222 may include an adsorbent. The adsorbent may adsorb a specific material in gaseous form. For example, the adsorbent may include at least one of activated carbon, zeolite, alumina, silica gel, and bentonite. The adsorbent may take a particle form, and a plurality of adsorbent particles may be evenly distributed on the entire filter material, but one or more embodiments are not limited thereto.

The aerosol generating article 2 may include a wrapper 24 that surrounds at least a portion of the aerosol generating rod 21 and at least a portion of the filter rod 22. The wrapper 24 may include a single wrapper or a combination of multiple wrappers, such as a first wrapper 241, a second wrapper 242, a third wrapper 243, a fourth wrapper 244, a final wrapper 24F, and tip paper 24T.

The wrapper 24 may include paper. For example, the wrapper 24 may include paper having a thickness of about 10 μm to about 150 μm and a basis weight of about 20 g/m² to about 100 g/m². When the wrapper 24 includes a plurality of wrappers, the thickness and basis weight of the paper in each wrapper may be the same or different.

The aerosol generating article 2 may be wrapped multiple times by two or more wrappers. For example, the first aerosol generating rod 211 may be packaged by the first wrapper 241, the second aerosol generating rod 212 may be packaged by the second wrapper 242, the first segment 221 may be packaged by the third wrapper 243, the second segment 222 may be packaged by the fourth wrapper 244, and the first aerosol generating rod 211, the second aerosol generating rod 212, the first segment 221, and the second segment 222 may entirely be repackaged by the final wrapper 24F.

The first wrapper 241 and the second wrapper 242 may surround the aerosol generating rod 21. For example, the first wrapper 241 may surround the first aerosol generating rod 211, and the second wrapper 242 may surround the second aerosol generating rod 212.

The first wrapper 241 and the second wrapper 242 may each include a heat-conductivity improving material. The heat-conductivity improving material may include metal foil such as aluminum foil, but is not limited thereto. The heat-conductivity improving material may improve the heat conductivity of the first wrapper 241 and the second wrapper 242 and may evenly distribute the heat transmitted to the first aerosol generating rod 211 and the second aerosol generating rod 212. For example, the first wrapper 241 and the second wrapper 242 may each be a laminated sheet in which paper and metal foil are stacked. The first wrapper 241 and the second wrapper 242 may each be a laminated sheet in which paper is placed on one surface of metal foil or a laminated sheet in which paper is placed on both surfaces of metal foil.

The third wrapper 243 and the fourth wrapper 244 may surround the filter rod 22. For example, the third wrapper 243 may surround the first segment 221, and the fourth wrapper 244 may surround the second segment 222.

The third wrapper 243 may include at least one perforation 243P. For example, the third wrapper 243 may surround the first segment 221, and the perforation 243P of the third wrapper 243 may be at a location corresponding to the perforation 221P of the first segment 221.

The fourth wrapper 244 may have oil resistance. As the fourth wrapper 244 has oil resistance, leakage of flavoring agents in the second segment 222 and/or the capsule 23 to the outside of the aerosol generating article 2 may be prevented. For example, the fourth wrapper 244 may include at least one oil-resistant material among polyvinyl alcohol and silicon. The surface of the fourth wrapper 244 may be coated with an oil-resistant material.

The final wrapper 24F may collectively surround the first aerosol generating rod 211, the second aerosol generating rod 212, the first segment 221, and the second segment 222. The final wrapper 24F may protect the outer surface of the aerosol generating article 2 to facilitate smooth insertion of the aerosol generating article 2 into the aerosol generating device 1.

The final wrapper 24F may include at least one perforation 24FP. For example, the final wrapper 24F may surround the first segment 221, and the perforation 24FP of the final wrapper 24F may be at a location corresponding to the perforation 221P of the first segment 221.

The wrapper 24 may include tip paper 24T. The tip paper 24T may surround some portions of the aerosol generating article 2 extending from the downstream end of the aerosol generating article 2 in the longitudinal direction of the aerosol generating article 2. For example, the tip paper 24T may surround regions corresponding to the entire second segment 222 and a portion of the first segment 221. The tip paper 24T may come into contact with the user's mouth during the use of the aerosol generating article 2.

The tip paper 24T may include at least one perforation 24TP. For example, the tip paper 24T may surround the first segment 221, and the perforation 24TP of the tip paper 24T may be at a location corresponding to the perforation 221P of the first segment 221.

The outer surface of the tip paper 24T may be coated with a material, such as a sweetener and a lip release agent. The sweetener may provide a sweet flavor to the user. For example, the sweetener may include sucralose, citric acid, or the like, but is not limited thereto. The lip release agent may allow the user's mouth to be easily separated from the tip paper 24T after contacting the tip paper 24T. For example, the lip release agent may include at least one of nitrocellulose, ethyl acetate, polyamide, and isopropylalcohol, but is not limited thereto.

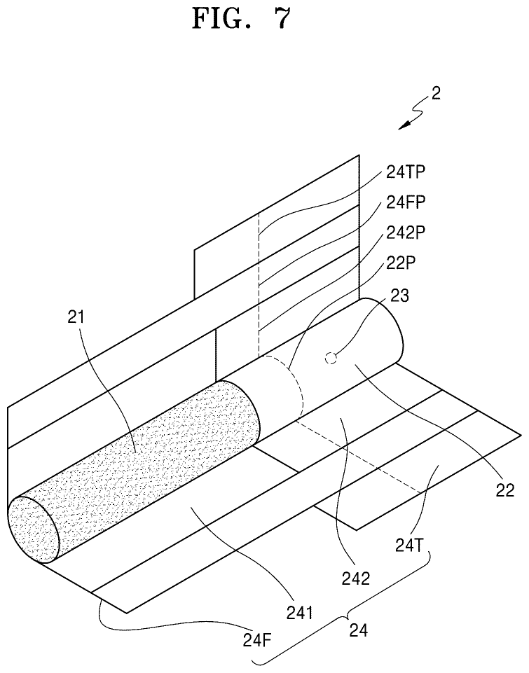

FIG. 7 illustrates the aerosol generating article 2 according to an embodiment.

Referring to FIG. 7, the aerosol generating article 2 may include an aerosol generating rod 21 and a filter rod 22. Also, the aerosol generating article 2 may be packaged by at least one wrapper 24. The aerosol generating article 2 shown in FIG. 7 may generate an aerosol through combustion.

The aerosol generating rod 21 may include a tobacco material. The tobacco material may include nicotine and, when burned, may generate an aerosol containing nicotine vapor. The aerosol generating rod 21 may be burned when the aerosol generating article 2 is used. For example, ignition may occur at the upstream end of the aerosol generating rod 21, and combustion may proceed from the upstream end of the aerosol generating rod 21 to the downstream end thereof.

The tobacco material may include various shapes. For example, the tobacco material may have at least one form from among sheets, pipe tobacco, strands, particles, beads, granules, powders, and extracts, but are not limited thereto.

The tobacco material may be manufactured using at least one of leaf tobacco ingredients and reconstituted tobacco ingredients. The leaf tobacco ingredients may include at least one of yellow tobacco, burley tobacco, and oriental tobacco, but one or more embodiments are not limited thereto. The reconstituted tobacco ingredients may refer to tobacco ingredients that are reconstituted using tobacco byproducts. For example, the reconstituted tobacco ingredients may include tobacco sheets.

The tobacco material may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco material may include other additives, such as flavoring agents and organic acids.

For example, the aerosol generating rod 21 may include a plurality of cut tobaccos. The cut tobacco may be manufactured according to a manufacturing method including mixing leaf tobacco ingredients, adding flavors to the mixed leaf tobacco ingredients, and manufacturing cut tobacco by chopping the flavored leaf tobacco ingredients.

In the mixing of the leaf tobacco ingredients, leaf tobacco ingredients of different types are mixed at predetermined ratios. For example, the mixing of the leaf tobacco ingredients may include mixing yellow tobacco with burley tobacco. However, one or more embodiments are not limited thereto, and a single type of leaf tobacco ingredients may be used.

In the adding of the flavors to the mixed leaf tobacco ingredients, the occurrence of irritation or unpleasant taste during smoking may be suppressed, and properties such as a moisture-retaining property and a flavor-stabilizing property may be imparted to the cut tobacco. The adding may include spraying a flavoring liquid onto the leaf tobacco ingredients. The flavoring liquid may be a mixture of sugars (e.g., sucrose), organic acids (e.g., citric acid, tartaric acid, etc.), aerosol-generating materials (e.g., glycerin, propylene glycol, etc.), and flavoring agents (e.g., licorice extract, cocoa, etc.).

The method of manufacturing a cut tobacco may include a toasting operation. The toasting operation may refer to a process of adding sugars and acids to leaf tobacco ingredients, inducing a thermal reaction at a high temperature, and manufacturing toasted leaves with improved tastes. The toasted leaves may be mixed in the mixing of the leaf tobacco ingredients or the manufacturing of the cut tobacco.

The toasting operation may include a toasting first casing operation, a toasting treatment operation, and a toasting top dressing operation. The descriptions provided above with regard to the adding of the flavors may be identically or similarly applied to the toasting casing operation and the toasting top dressing operation. The toasting treatment operation may include a drying operation, a cooling operation, and a moisture adjusting operation for the leaf tobacco ingredients, and respective operations may be sequentially performed.

The aerosol generating rod 21 may include at least one tobacco sheet. The tobacco sheet may include at least one of a slurry-type tobacco sheet and a paper-type tobacco sheet. The slurry-type tobacco sheet and the paper-type tobacco sheet may be distinguished based on manufacturing methods thereof. At least one tobacco sheet may be arranged to extend along the longitudinal direction of the aerosol generating rod 21. However, one or more embodiments are not limited thereto, and the aerosol generating rod 21 may include a plurality of cut tobacco sheets manufactured by cutting or finely cutting the tobacco sheet.

The slurry-type tobacco sheet may be manufactured according to a manufacturing method including preparing a slurry containing tobacco ingredients, casting the slurry to form a sheet, and drying the sheet to manufacture a tobacco sheet. In the slurry, tobacco ingredients, water, aerosol generating materials (e.g., glycerin, propylene glycol, etc.), flavoring agents, and binders (e.g., guar gum, xanthan gum, carboxymethyl cellulose, etc.) may be mixed. Here, the tobacco ingredients may be tobacco leaves, tobacco stems, and/or tobacco powder generated during the tobacco processing. In addition, natural pulp or cellulose may be added to the slurry, and one or more binders are mixed and used. The manufactured tobacco sheet may be crimped to include wrinkles.

The paper-type tobacco sheet may be manufactured according to a manufacturing method including preparing a slurry including tobacco ingredients, extracting the slurry and separating water-soluble materials and fibrous materials from each other, producing a base sheet by using the fibrous materials, and applying the water-soluble materials to the base sheet, drying moisture, and manufacturing a tobacco sheet. Here, the fibrous materials may be refined to a state suitable for producing a base sheet. In addition, the water-soluble materials may be condensed before being applied to the base sheet and may be mixed with aerosol generating materials (e.g., glycerin, propylene glycol, etc.), flavoring agents, and the like. The manufactured tobacco sheet may be crimped to include wrinkles.

The aerosol generating rod 21 may include at least one of an expanded stem and an expanded midrib. The expanded stem and the expanded midrib may be manufactured by expanding leaf tobacco ingredients and byproducts thereof, such as midribs.

The filter rod 22 may filter some components included in the aerosol passing through the filter rod 22. The filter rod 22 may include a filter material. For example, the filter rod 22 may include at least one filter material selected from paper, cellulose acetate, polylactic acid, polypropylene, and lyocell. For example, the filter rod 22 may be fabricated by adding a plasticizer (e.g., triacetin) to cellulose acetate tow.

The filter material may include fibrous materials having a denier per filament of about 1 to about 30 and a total denier of about 10000 to about 200000. For example, the filter material may include cellulous acetate tow having a denier per filament of about 2 to about 15 and a total denier of about 20000 to about 100000, but one or more embodiments are not limited thereto.

The filter rod 22 may be a cylindrical rod or a tube-type rod including a hollow inside, but the shape of the filter rod 22 is not limited thereto. For example, the filter rod 22 may include a hollow with an open downstream end.

The filter rod 22 may include a plurality of segments. The segments may be sequentially arranged along the lengthwise direction of the aerosol generating article 2. The segments may have the same shape or similar shapes, but one or more embodiments are not limited thereto. For example, the filter rod 22 may be formed by sequentially arranging a tube-type segment, which includes a hollow, and a cylindrical segment along the longitudinal direction.

The filter rod 22 may include the perforation 22P. The perforation 22P may be formed along the circumferential direction of the filter rod 22 and thus form at least one column. External air may be introduced into the filter rod 22 through the perforation 22P. The external air flowing into the filter rod 22 may be mixed with the aerosol generated by the aerosol generating rod 21, thereby diluting the aerosol.

The filter rod 22 may add a flavor to the aerosol passing through the filter rod 22. For example, the filter rod 22 may include flavoring agents. The flavoring agent may be sprayed onto the filter rod 22 in liquid form, but is not limited thereto. As another example, separate fibers including flavoring agents may be inserted into the filter rod 22.

The flavoring agent may include menthol, but is not limited thereto. For example, the flavoring agent may also include plant-based flavors, such as cinnamon, sage, herbs, chamomile, kudzu (galcho), licorice, lavender, bergamot, lemon, orange, jasmine, ginger, vanilla, spearmint, peppermint, acacia, coffee, celery, sandalwood, and cocoa. As another example, the flavoring agent may include animal-derived flavors, such as musk, ambergris, civet, and castoreum.

The flavoring agent may be an alcohol compound, such as geraniol, linalool, anethol, or eugenol. The flavoring agent may be an aldehyde compound such as vanillin, benzaldehyde, anisaldehyde, or the like. The flavoring agent may be an ester compound, such as isoamyl acetate, linalyl acetate, isoamyl propionate, or linalyl butyrate.

The filter rod 22 may include at least one capsule 23. The at least one capsule 23 may be embedded in the filter material. The capsule 23 may generate flavors or aerosols. For example, the capsule 23 may have a structure in which a liquid containing a flavoring agent is enclosed by a film. The film of the capsule 23 may be broken by external pressure and release the liquid therein. The liquid released from the capsule 23 may be absorbed into the filter material of the filter rod 22. The capsule 23 may have a spherical or cylindrical shape, but is not limited thereto.

The filter rod 22 may include an adsorbent. The adsorbent may adsorb a specific material in gaseous form. For example, the adsorbent may include at least one of activated carbon, zeolite, alumina, silica gel, and bentonite. The adsorbent may take a particle form, and a plurality of adsorbent particles may be evenly distributed on the entire filter material, but one or more embodiments are not limited thereto. As another example, the adsorbent may be arranged on the inner surface of the wrapper contacting the outer surface of the filter rod 22.

The aerosol generating article 2 may include the wrapper 24 that surrounds at least a portion of the aerosol generating rod 21 and the filter rod 22. The wrapper 24 may be a single wrapper or a combination of wrappers 241, 242, 24F, and 24T.

The wrapper 24 may include paper. For example, the wrapper 24 may include paper having a thickness of about 10 μm to about 150 μm and a basis weight of about 20 g/m² to about 100 g/m². When the wrapper 24 includes a plurality of wrappers, the thickness and basis weight of the paper included in each wrapper may be the same or different.

The aerosol generating article 2 may be doubly packaged by at least two wrappers. For example, the aerosol generating rod 21 may be packaged by the first wrapper 241, the filter rod 22 may be packaged by the second wrapper 242, and the aerosol generating rod 21 and the filter rod 22 may be repackaged by the final wrapper 24F.

The first wrapper 241 may surround the aerosol generating rod 21. The first wrapper 241 may be burned together with the aerosol generating rod 21 as the combustion of the aerosol generating rod 21 progresses. The first wrapper 241 may include a burning aid for facilitating the combustion of the aerosol generating rod 21. The burning aid may include at least one of citrates, acetates, phosphates, tartrates, and nitrates, but is not limited thereto. For example, the burning aid may include at least one of ammonium phosphate, sodium citrate, and potassium citrate.

In addition, the first wrapper 241 may include a burning inhibitor. The burning inhibitor may suppress the combustion of the first wrapper 241 when the aerosol generating article 2 remains unattended without being fully burned after its use, thereby inducing self-extinguishment of the first wrapper 241. The burning inhibitor may be applied to the surface of the first wrapper 241, but is not limited thereto. For example, the first wrapper 241 may include a plurality of regions arranged along the circumferential direction and including the burning inhibitor, and the regions may be spaced apart from each other along the longitudinal direction of the aerosol generating article 2.

The second wrapper 242 may surround the filter rod 22. The second wrapper 242 may have oil resistance. Because the second wrapper 242 has oil resistance, the flavoring agents included in the filter rod 22 and/or the capsule 23 may be prevented from leaking to the outside of the aerosol generating article 2. For example, the second wrapper 242 may include at least one oil-resistant material among polyvinyl alcohol and silicon. The surface of the second wrapper 242 may be coated with an oil-resistant material.

The second wrapper 242 may include the perforation 242P. For example, the second wrapper 242 may surround the filter rod 22, the perforation 242P of the second wrapper 242 may be at a location corresponding to the perforation 22P of the filter rod 22.

The final wrapper 24F may collectively surround the aerosol generating rod 21 and the filter rod 22. The final wrapper 24F may prevent the contamination of the exterior of the aerosol generating article 2. The final wrapper 24F may be omitted according to necessity.

The final wrapper 24F may include the perforation 24FP. For example, the final wrapper 24F may surround the filter rod 22, and the perforation 24FP of the final wrapper 24F may be at a location corresponding to the perforation 22P of the filter rod 22.

The wrapper 24 may include tip paper 24T. The tip paper 24T may be coupled to the aerosol generating rod 21 and the filter rod 22. The tip paper 24T may surround some portions of the aerosol generating article 2 extending from the downstream end of the aerosol generating article 2 along the longitudinal direction of the aerosol generating article 2. For example, the tip paper 24T may surround regions corresponding to the entire filter rod 22 and a portion of the aerosol generating rod 21. The tip paper 24T may come into contact with the user's mouth during the use of the aerosol generating article 2.

The tip paper 24F may include the perforation 24TP. For example, the tip paper 24T may surround the filter rod 22, and the perforation 24TP of the tip paper 24T may be at a location corresponding to the perforation 22P of the filter rod 22.

The outer surface of the tip paper 24T may be coated with a material, such as a sweetener and a lip release agent. The sweetener may provide a sweet flavor to the user. For example, the sweetener may include sucralose, citric acid, or the like, but is not limited thereto. The lip release agent may allow the user's mouth to be easily separated from the tip paper 24T after contacting the tip paper 24T. For example, the lip release agent may include at least one of nitrocellulose, ethyl acetate, polyamide, and isopropylalcohol, but is not limited thereto.

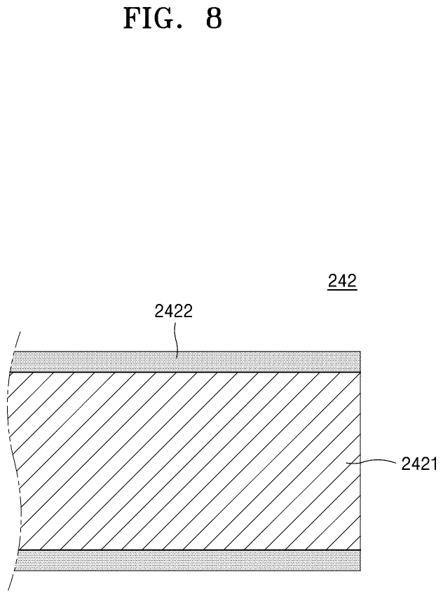

FIG. 8 illustrates a filter wrapper for an aerosol generating article, according to an embodiment.

FIG. 8 illustrates an enlarged cross-section of a filter wrapper 242 for an aerosol generating article, according to an embodiment. The filter wrapper 242 according to an embodiment may refer to any one of the second wrappers 242 shown in FIGS. 4, 5, and 7 or the fourth wrapper 244 shown in FIG. 6.

Referring to FIG. 8, the filter wrapper 242 for an aerosol generating article according to an embodiment may include a paper layer 2421 and coating layers 2422 arranged on opposite surfaces of the paper layer 2421. However, the structure of the filter wrapper 242 is not limited thereto. The coating layer 2422 may be arranged on only one surface of the paper layer 2421 and not be arranged on the opposite surface of the paper layer 2421.

The coating layer 2422 may include one or more polymer resins selected from the group consisting of acryl-based resin and polyvinyl alcohol-based resin. The coating layer 2422 may have oil resistance, and the coating layer 2422 having oil resistance may prevent the contamination of the filter wrapper 242 by fat-soluble materials. For example, in the case of a filter including a capsule, a flavoring liquid (e.g., a liquid containing a flavoring agent) within the capsule may be released when the capsule is broken. The flavoring liquid may reach the filter wrapper 242 by pressure applied to the inside of the capsule when the capsule is broken. Because the flavoring liquid mainly includes oil, the filter wrapper 242 is required to have oil resistance to prevent contamination by the flavoring liquids.

In the case of existing oil-resistant filter wrappers, a fluorine-based resin is generally used as a coating material. However, the fluorine-based resin is unstable under high-temperature conditions and thus may be unsuitable for a filter wrapper for an aerosol generating article that involves heating and/or combustion. In contrast, the filter wrapper 242 for an aerosol generating article according to an embodiment includes the coating layers 2422 containing acryl-based resin and/or polyvinyl alcohol-based resin with relatively excellent heat stability, and thus, the above-described problems may be prevented.

The acryl-based resin may refer to resin including an acryl monomer in an amount of at least about 70 wt %, about 75 wt %, about 80 wt %, or about 85 wt % among the total monomers forming resins. For example, the acryl-based resin may be an acryl polymer including polymer units derived from (meta) acrylic ester monomers.

The acryl-based resin may have a solid content of about 10 wt % to about 40 wt % and include an ester compound in an amount of about 30 wt % to about 60 wt %. For example, the acryl-based resin may have a solid content of about 15 wt % to about 35 wt % or about 20 wt % to about 30 wt %. In addition, the acryl-based resin may include an ester compound in an amount of 35 wt % to about 55 wt % or about 40 wt % to about 50 wt %.

The polyvinyl alcohol-based resin may be manufactured by polymerizing polyvinyl ester-based polymer, such as polyvinyl acetate, as a precursor, dissolving the polyvinyl ester-based polymer in a solvent, and saponifying the polymer by adding a catalyst. Because polyvinyl alcohol is a linear polymer containing hydroxyl groups, which has oil resistance and facilitates film formation, polyvinyl alcohol may be suitable for forming the coating layers 2422 of the filter wrapper 242.

The polyvinyl alcohol-based resin may have a solid content of about 1 wt % to about 10 wt %. For example, the polyvinyl alcohol-based resin may have a solid content of about 2 wt % to about 8 wt % or about 3 wt % to about 7 wt %.

An adhesive for attaching the filter wrapper 242 to filter tow may be used to manufacture a filter for an aerosol generating article by wrapping the filter tow with the filter wrapper 242. In general, the adhesive for attaching the filter wrapper 242 to filter tow may be a hydrophilic hot melt adhesive including ethylene-vinyl acetate copolymer (EVA). Because a general acryl-based resin and/or polyvinyl alcohol-based resin exhibits both excellent oil resistance and excellent water resistance, a hydrophilic adhesive may hardly penetrate the wrapper, and thus, the adhesion between the filter tow and the filter wrapper 242 may decrease.

However, when the solid content of the acryl-based resin and the content of the ester compound, and/or the solid content of the polyvinyl alcohol-based resin fall within the aforementioned ranges, the water resistance of the coating layers 2422 may be adjusted, and the hydrophilic adhesive may penetrate the coating layers 2422 and reach the paper layer 2421. Accordingly, the filter wrapper 242 for an aerosol generating article according to an embodiment may form a filter that exhibits adhesion to the filter tow while maintaining oil resistance.

The weight of the coating layer 2422 may be about 3.5% to about 9% of the weight of the paper layer 2421. When the coating layer 2422 falls within the above-stated weight range, the adhesion between the filter wrapper 242 and the filter tow may be improved while the filter wrapper 242 maintains appropriate oil resistance. When the weight of the coating layer 2422 is less than about 3.5% of the weight of the paper layer 2421, the oil resistance of the filter wrapper 2422 may be insufficient. When the weight of the coating layer 2422 is greater than about 9% of the weight of the paper layer 2421, the adhesion between the filter wrapper 242 and the filter tow may be insufficient. For example, the weight of the coating layer 2422 may be about 4% to about 8% or about 4.5% to about 7% of the weight of the paper layer 2421.

The paper layer 2421 may include a paper sheet. The basis weight of the paper layer 2421 may be about 25 g/m² to about 90 g/m². For example, the basis weight of the paper layer 2421 may be about 25 g/m² to about 60 g/m² or about 30 g/m² to about 40 g/m². In addition, the thickness of the paper layer 2421 may be about 30 μm to about 70 μm. For example, the thickness of the paper layer 2421 may be about 30 μm to about 60 μm or about 35 μm to about 50 μm.

The sizing degree of the paper layer 2421 may be about 3 sec to about 5 sec. The sizing degree may be measured according to the Stockigt sizing method. The sizing degree according to the Stockigt sizing method may be obtained by floating a test sheet on a 2% ammonium thiocyanate solution at a temperature of about 20±1° C., adding a drop of 1% ferric chloride solution with a pipette, and measuring the time taken until red spots appear.

The air permeability of the paper layer 2421 may be at least about 130 sec. When the air permeability and the sizing degree of the paper layer 2421 fall within the aforementioned ranges, the filter wrapper 242 may exhibit excellent oil resistance. When the air permeability and the sizing degree of the paper layer 2421 fall outside the aforementioned ranges, the paper layer 2421 may be separated from the coating layer 2422 due to insufficient adhesion therebetween, and thus, the oil resistance of the filter wrapper 242 may degrade.

The sizing degree of the filter wrapper 242 for an aerosol generating article according to an embodiment may be about 40 sec to about 70 sec. A hydrophilic adhesive may be absorbed into the filter wrapper 242 within the above range, thereby improving adhesion between the filter wrapper 242 and the filter tow. For example, the sizing degree of the filter wrapper 242 according to an embodiment may be about 41 sec to about 65 sec or about 42 sec to about 62 sec.

The filter wrapper 242 for an aerosol generating article according to an embodiment may have oil resistance of about 6 to about 11 in a test conducted according to Tappi T559 standards. Within the above range, the filter wrapper 242 may have appropriate oil resistance to prevent contamination.

The product of the oil resistance and the sizing degree (sec) of the filter wrapper 242 for an aerosol generating article according to an embodiment, measured in a test conducted according to Tappi T559 standards, may be at least about 250. Within the aforementioned range, the filter wrapper 242 may exhibit both appropriate oil resistance and great adhesion to the filter tow. For example, the product of the oil resistance and the sizing degree (sec) of the filter wrapper 242 for an aerosol generating article according to an embodiment, measured in a test conducted according to Tappi T559 standards, may be about 270 to about 1100 or about 280 to about 550.

Experimental Example 1: Filter Wrapper Including Coating Layers Containing Acryl-Based Resin

A filter wrapper including coating layers containing acryl-based resin was prepared. The coating layers were formed on both sides of the paper layer so that the filter wrapper had the same structure as that shown in FIG. 8. Acryl-based resin in the coating layers had a solid content of about 25 wt % and contained about 45% of an ester-based compound. The physical properties of the paper layer and the manufactured filter wrapper were measured, and the results are presented in Table 1 below.

TABLE 1

| | | | | | Filter wrapper | | | |
|---|---|---|---|---|---|---|---|---|
| | Paper layer | | | | weight of | oil | | |
| | basis | | air | sizing | coating | resistance | sizing | filter |
| | weight | thickness | permeability | degree | layer | (Tappi | degree | filter |
| Embodiment | (gsm) | (μm) | (sec) | (sec) | (%) | 559) | (sec) | suitability |
| 1 | 40 | 40 | 5-6 | X | 7.3 | 2 | 0 | Δ |
| 2 | 40 | 40 | 15-20 | 4-5 | 5.3 | 4 | 35 | Δ |
| 3 | 35 | 40 | 150 | 3-5 | 9.0 | 11 | 97 | ◯ |
| 4 | 35 | 40 | 150 | 3-5 | 5.1 | 7 | 42 | ⊚ |
| 5 | 35 | 40 | 150 | 3-5 | 3.0 | 4 | 32 | Δ |

Referring to Table 1, the filter suitability was determined by considering whether the filter wrapper was contaminated and the adhesion between the filter wrapper and the filter tow when a filter was prepared using the filter wrapper, and the filter suitability was indicated using the symbols ⊚, ◯, Δ, and X in descending order to performance.

As shown in Table 1, it was confirmed that the basis weight, thickness, and air permeability of the paper layer and the weight, oil resistance, and sizing degree of the coating layer of the filter wrapper affect filter suitability. Specifically, it was identified that the product of oil resistance and sizing degree for Embodiment 4 was 294 and that for Embodiment 3 was 1067, which indicates excellent filter suitability.

### Experimental Example 1: Filter Wrapper Including Coating Layers Containing Polyvinyl Alcohol-Based Resin

Except for using polyvinyl alcohol-based resin having a solid content of about 5 wt %, Experimental Example 2 was conducted in the same manner as Experimental Example 1 to measure the physical properties of the paper layers and the manufactured filter wrappers. The results are presented in Table 2 below.

TABLE 2

| | | | | | Filter wrapper | | | |
|---|---|---|---|---|---|---|---|---|
| | Paper layer | | | | weight of | oil | | |
| | basis | | air | sizing | coating | resistance | sizing | filter |
| | weight | thickness | permeability | degree | layer | (Tappi | degree | filter |
| Embodiment | (gsm) | (μm) | (sec) | (sec) | (%) | 559) | (sec) | suitability |
| 6 | 40 | 40 | 5-6 | X | 3.1 | 0 | 0 | Δ |
| 7 | 40 | 40 | 15-20 | 4-5 | 3.2 | 1-2 | 19 | Δ |
| 8 | 35 | 40 | 130 | 3-5 | 3.9 | 8 | 62 | ⊚ |

As shown in Table 2, similar to Experimental Embodiment 1, it was confirmed that the basis weight, thickness, and air permeability of the paper layer and the weight, oil resistance, and sizing degree of the coating layer of the filter wrapper affect filter suitability. Specifically, the product of oil resistance and the sizing degree of the filter wrapper for Embodiment 8 was 496, which indicates the highest filter suitability.

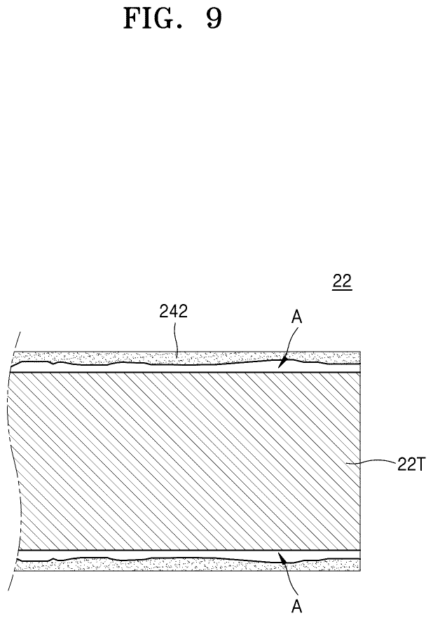

FIG. 9 illustrates a filter for an aerosol generating article, according to an embodiment.

FIG. 9 may be a diagram illustrating an enlarged cross-section of a filter 22 for an aerosol generating article, according to an embodiment. The filter 22 for an aerosol generating article according to an embodiment may refer to any one of the filter rods 22 shown in FIGS. 4 to 7.

Referring to FIG. 9, the filter 22 for an aerosol generating article according to an embodiment may include filter tow 22T and a filter wrapper 242 surrounding the filter tow 22T.

The filter tow 22T may include a plurality of filter fibers. The filter tow 22T may have a cylindrical shape in which the filter fibers are aggregated, but the shape thereof is not limited thereto. The filter fibers included in the filter tow 22T may be arranged to extend between both ends of the filter tow 22T. For example, the filter tow 22T may include cellulose acetate tow including a plurality of cellulose acetate fibers. Because the above descriptions may be identically or similarly applied to the cellulose acetate tow, repeated descriptions are omitted.

As shown in FIG. 9, the filter tow 22T may adhere to the filter wrapper 242 by a hydrophilic adhesive A. Because the hydrophilic adhesive A may penetrate into the filter wrapper 242 (e.g., a paper layer), the filter tow 22T may stably adhere to the filter wrapper 242. The hydrophilic adhesive A may be a hot melt adhesive including EVA.

Although not shown in FIG. 9, a capsule containing a flavoring liquid may be arranged within the filter tow 22T of the filter for an aerosol generating article according to an embodiment. Because the above descriptions may be identically or similarly applied to the capsule, repeated descriptions are omitted.

Certain embodiments or other embodiments of the disclosure described above are not exclusive or distinct from each other. The certain embodiments or other embodiments of the disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly and should be considered as exemplary in all aspects. The scope of the disclosure should be determined by a rational interpretation of the attached claims, and all changes within the equivalent scope of the disclosure are included in the scope of the disclosure.

According to the one or more embodiments, because a coating layer includes polymer resin with excellent heat stability, a filter wrapper that is suitable for an aerosol generating article exposed to high temperatures during use may be provided.

In addition, according to the one or more embodiments, a filter wrapper for an aerosol generating article may form a filter that may prevent contamination due to oil resistance while exhibiting excellent adhesion to filter tow.

Effects of the embodiments are not limited to those stated above, and effects that are not described herein may be clearly understood by one of ordinary skill in the art from the present specification and the attached drawings.

What is claimed is:

1. A filter wrapper for an aerosol generating article, the filter wrapper comprising:
a paper layer; and
a coating layer arranged on at least one surface of the paper layer,
wherein the coating layer comprises one or more polymer resins selected from the group consisting of acryl-based resin and polyvinyl alcohol-based resin.

2. The filter wrapper of claim 1, wherein the acryl-based resin has a solid content of about 10 wt % to about 40 wt % and comprises about 30 wt % to about 60 wt % of an ester-based compound.

3. The filter wrapper of claim 1, wherein the polyvinyl alcohol-based resin has a solid content of about 1 wt % to about 10 wt %.

4. The filter wrapper of claim 1, wherein a weight of the coating layer is about 3.5% to about 9% of a weight of the paper layer.

5. The filter wrapper of claim 1, wherein a basis weight of the paper layer is about 25 g/m² to about 90 g/m² and a thickness of the paper layer is about 30 μm to about 70 μm.

6. The filter wrapper of claim 1, wherein a sizing degree of the paper layer is about 3 sec to about 5 sec.

7. The filter wrapper of claim 1, wherein air permeability of the paper layer is at least about 130 sec.

8. The filter wrapper of claim 1, wherein the filter wrapper has oil resistance of about 6 to about 11 in a test conducted according to Tappi T559 standards.

9. The filter wrapper of claim 1, wherein a sizing degree of the filter wrapper is about 40 sec to about 70 sec.

10. The filter wrapper of claim 1, wherein a product of oil resistance and sizing degree (sec) of the filter wrapper in a test conducted according to Tappi T559 standards is at least about 250.

11. A filter for an aerosol generating article, the filter comprising:
filter tow comprising a filter fiber; and
a filter wrapper according to claim 1, the filter wrapper surrounding the filter tow.

12. The filter of claim 11, further comprising a capsule arranged within the filter tow and containing a flavoring liquid.

13. The filter of claim 11, wherein the filter tow adheres to the filter wrapper by a hydrophilic adhesive.

14. The filter of claim 13, wherein the hydrophilic adhesive comprises a hot melt adhesive comprising ethylene-vinyl acetate copolymer (EVA).
